(19) United States
(12) Patent Application Publication
(10) Pub. No.: US 2026/0021001 A1
(43) Pub. Date: Jan. 22, 2026

(54) JOINT MOBILIZATION APPLIANCE

(71) Applicant: Full Motion LLC, Fircrest, WA (US)

(72) Inventors: Benjamin L. HANNULA, Fircrest, WA (US); Chad J. MCCANN, Tacoma, WA (US)

(21) Appl. No.: 19/269,721

(22) Filed: Jul. 15, 2025

Related U.S. Application Data
(60) Provisional application No. 63/672,004, filed on Jul. 16, 2024.
(60) Provisional application No. 63/686,903, filed on Aug. 26, 2024.

(51) Int. Cl. A61H 1/02

(52) U.S. Cl. CPC A61H 1/0266; A61H 2201/1253; A61H 2201/1642

(57) ABSTRACT

A joint mobilization appliance comprising a base having a foot receiving area, a force transmission lever pivotally connected to and extending upwardly from the base, with an upper portion of the force transmission lever distal the base being configured to be rotated toward the foot receiving area of the base or toward a body of a person using the joint mobilization appliance, an ankle abutment member or an ankle position fixing member configured to abut against or fix an ankle joint of a person using the joint mobilization appliance, and a rear leg abutment member interconnected to the force transmission lever. In use, rotation of the force transmission lever forces the rear leg abutment member to force a back of a distal lower leg below a knee of the person forward to force ankle dorsiflexion.

### CROSS-REFERENCE TO RELATED APPLICATIONS

This claims the benefit of U.S. Provisional Application No. 63/672,004, filed Jul. 16, 2024, and U.S. Provisional Application No. 63/686,903, filed Aug. 26, 2024, the disclosures all of which are hereby incorporated by reference in their entireties.

### FIELD OF THE INVENTION

The present invention relates to physical therapy, and in particular to a joint mobilization appliance.

### BACKGROUND OF THE INVENTION

Joint mobilization is a type of manual therapy performed by a physical therapist, often in a physical therapy setting or clinic. Joint mobilization involves the movement of specific joints using the skilled application of force, direction and technique. A physical therapist can use their hands to mobilize an affected joint or may elect to use certain tools, including straps, to help deliver the desired treatment effect.

The specific type, magnitude, speed and frequency of joint mobilization performed depends on several factors, including the goal of treatment, the type of joint being targeted and human anatomy. Primary effects of joint mobilization include pain reduction, improved range of motion, and improved quality of joint movement (i.e., arthrokinematics).

A commonly utilized technique in physical therapy to improve ankle dorsiflexion range of motion is referred to as mobilization with movement (MWM). In this technique, a patient positions an elastic resistance band just inferior to a level of their ankle malleoli, allowing for a sustained posterior and slightly caudal-directed force to be applied to an anterior aspect of the talocrural joint. This external force serves to stabilize the talus and facilitate posterior glide relative to the tibia and fibula. In the absence of a resistance band, the clinician may alternatively use the web space of their hand to apply a comparable mobilizing force. While maintaining this stabilization, the patient actively drives the knee anteriorly over the foot to achieve maximal dorsiflexion. Concurrently, the clinician may apply an anterior-directed force to the posterior aspect of the distal tibia to assist in the anterior translation of the tibia and fibula over the talus. This coordinated mobilization strategy aims to enhance arthrokinematic motion and restore functional dorsiflexion within a closed kinetic chain.

Optimal ankle dorsiflexion range of motion is crucial for normal daily function, including, but not limited to, walking, stair descent, squatting and balance, as well as more dynamic movement, including, but not limited to, running, jumping and changes of direction. The ankle joint must move through full, normal ranges of motion to meet the requirements of a person's environment and activity to avoid injury to the ankle and other joints, tendons, muscles and other tissues through the kinetic chain. Medical providers often seek to restore ankle dorsiflexion to treat dysfunction and prevent future injury.

While medical providers can be focused on manual joint mobilizations as a form of passive movement treatment for musculoskeletal conditions, such as altered joint mechanics of the human ankle, more and more patients are seeking to create, strengthen, improve, restore, and rehabilitate ankle dorsiflexion range of motion and forefoot push-off power through the unassisted use of an externally applied orthopedic device or orthosis.

An example of an active treatment device is disclosed in U.S. Patent Application Publication No. 2022/0287905 entitled JOINT MOBILIZATION APPLIANCE FOR THE DISTAL LOWER EXTREMITY, the entire contents of which are hereby incorporated herein by reference.

Further improvements to prior art treatment devices are desired.

### SUMMARY OF THE INVENTION

The present invention, according to one aspect, is directed to a joint mobilization appliance comprising a base having a foot receiving area, a force transmission lever pivotally connected to and extending upwardly from the base, with an upper portion of the force transmission lever distal the base being configured to be rotated toward the foot receiving area of the base, an ankle abutment member configured to abut against an ankle joint of a person using the joint mobilization appliance, and a rear leg abutment member interconnected to the force transmission lever. In use, rotation of the force transmission lever forces the rear leg abutment member against a back of a distal lower leg below a knee of the person to force the back of the distal lower leg below the knee of the person forward to force ankle dorsiflexion.

Another aspect of the present invention is to provide a joint mobilization appliance comprising a base having a foot receiving area, a force transmission lever pivotally connected to and extending upwardly from the base, with an upper portion of the force transmission lever distal the base being configured to be rotated toward a body of a person using the joint mobilization appliance, an ankle position fixing member configured to fix an ankle joint of a person using the joint mobilization appliance in a locked position, and a rear leg abutment member interconnected to the force transmission lever. In use, rotation of the force transmission lever forces the rear leg abutment member to push against a back of a distal lower leg below a knee of the person to force the back of the distal lower leg below the knee of the person forward to force ankle dorsiflexion.

Yet another aspect of the present invention is to provide a joint mobilization appliance comprising a base, a lever pivotally connected to and extending upwardly from the base, a pull arm extending in a distal direction from a first side of the lever, an ankle abutment member extending in a proximal direction from a second side of the lever, and a pull member connected at a distal end of the pull arm. Rotation of the lever will force the distal end of the pull arm to pull the pull member in the distal direction opposite to the proximal direction. In use, the ankle abutment member abuts against an ankle of a person to maintain the ankle in a stationary position while the pull member pulls a back of a distal lower leg below a knee of the person forward toward the distal direction to force ankle dorsiflexion.

Another aspect of the present invention is to provide a joint mobilization appliance comprising a base, a lever arm pivotally connected to and extending upwardly from the base, an ankle abutment member extending from the lever arm, and a pull lever pivotally connected to the base. The pull lever has a rear leg abutment member connected thereto to rotate with rotation of the pull lever. In use, the ankle abutment member abuts against an ankle of a person to maintain the ankle in a stationary position while the pull lever pushes the rear leg abutment member against a back of a distal lower leg below a knee of the person to push the back of the distal lower leg below the knee of the person forward to force ankle dorsiflexion.

Other advantages, features, and functions of embodiments of a joint mobilization appliance having the features discussed herein will become readily apparent and better understood in view of the following description and accompanying drawings. The following description is not intended to limit the scope of the joint mobilization appliance, but instead merely provides exemplary embodiments for ease of understanding.

### BRIEF DESCRIPTION OF THE DRAWINGS

One or more embodiments of the present invention are illustrated by way of example and should not be construed as being limited to the specific embodiments depicted in the accompanying drawings.

FIG. 1 is a side view of a first embodiment of a joint mobilization appliance of the present invention.

FIG. 2 is a side view of the first embodiment of the joint mobilization appliance of the present invention in use by a person.

FIG. 3 is a side perspective view of a second embodiment of a joint mobilization appliance of the present invention.

FIG. 4 is a side view of a third embodiment of a joint mobilization appliance of the present invention.

FIG. 5 is a side view of the third embodiment of the joint mobilization appliance of the present invention in use by a person.

FIG. 6 is a front top perspective view of a fourth embodiment of a joint mobilization appliance of the present invention.

FIG. 7 is a rear top perspective view of the fourth embodiment of a joint mobilization appliance of the present invention.

FIG. 8 is a front bottom perspective view of the fourth embodiment of a joint mobilization appliance of the present invention.

FIG. 9 is a side view of the fourth embodiment of a joint mobilization appliance of the present invention.

FIG. 10 is a side view of the fourth embodiment of a joint mobilization appliance of the present invention illustrating movement of part of the fourth embodiment of a joint mobilization appliance relative to a lower body of a person.

FIG. 11 is a side view of the fourth embodiment of a joint mobilization appliance of the present invention in use by a person in a first body position.

FIG. 12 is a side view of the fourth embodiment of a joint mobilization appliance of the present invention in use by a person in a second body position.

The specific device and processes illustrated in the attached drawings and described in the following specification are simply exemplary embodiments of the inventive concepts. Hence, specific dimensions and other physical characteristics relating to the embodiments disclosed herein are not to be considered as limiting.

### DETAILED DESCRIPTION

For purposes of description herein, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined herein. Hence, specific dimensions and other physical characteristics relating to the embodiments disclosed herein are not to be considered as limiting, unless expressly stated otherwise.

Embodiments of a joint mobilization appliance are described herein and illustrated in the accompanying figures. The joint mobilization appliance can be used in environments in which it is desirable to diagnose, prevent, monitor, treat, alleviate or compensate for an injury; however, the illustrative examples provided are not intended to preclude embodiments of the joint mobilization appliance that may or may not yet be cleared for public use and commercial distribution. The joint mobilization appliance can include components which may be removable and replaceable, as well as washable and reusable.

Embodiments of a joint mobilization appliance are provided for use in stabilizing and supporting the lower leg, ankle, and foot. In each of the embodiments, features that are provided for one side of the device can be provided on the other side of the device. In this manner, it is intended that any of the embodiments of the joint mobilization appliance described herein may be used on either the right or left lower leg, ankle, and foot, with any appropriate reconfiguration of components that is deemed necessary for proper fit, form, and function of the appliance in support and stabilization of either the left or right distal lower extremity.

Additionally, embodiments of a joint mobilization appliance are provided for use to stabilize an ankle joint that has been weakened by injury or other infirmities. The appliance is configured to be properly tightened by all users, including the elderly or infirm.

In accordance with the present disclosure, embodiments of the joint mobilization appliance are particularly adapted for a human ankle joint and human talus bone, and can be dimensioned to accommodate different types, shapes, and sizes of human ankle joints and limbs.

In accordance with the present disclosure, each joint mobilization appliance embodiment or component thereof described herein may be divided into sections which are denoted by general anatomical terms for the human body. Such anatomical terms are provided to distinguish various elements of the device embodiments from one another, but are not to be considered to limit the scope of the disclosure.

The embodiments of the joint mobilization appliance can also be considered in terms of the intensity of the mobilization. The intensity variable is categorized in a grading system, e.g., the translatory glide mobilization grading has five grades (Grades I-V) ranging from small amplitude movement at the beginning of the available range of motion of the joint, or Grade I, to a high velocity thrust of small amplitude at the end of the available range and within its anatomical range (manipulation), or Grade V.

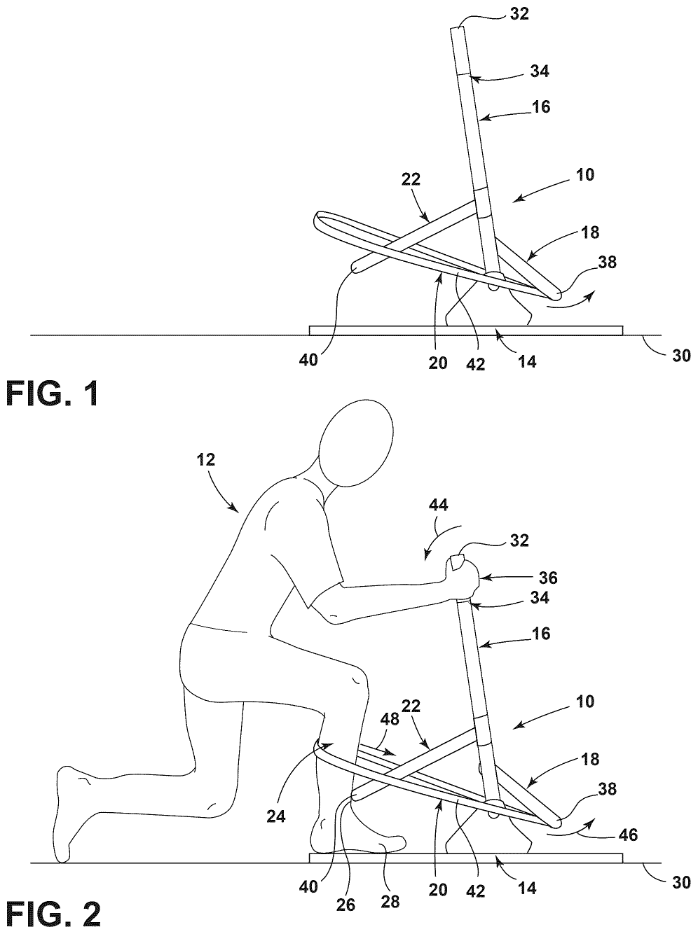

FIGS. 1 and 2 generally illustrate a first embodiment of a joint mobilization appliance 10 of the present invention for use by a person 12 (see FIG. 2). The joint mobilization appliance 10 includes a base 14, a force transmission lever 16 pivotally connected to the base 14, a pull arm 18 connected to the force transmission lever 16, a pull member 20 connected to the pull arm 18 and an ankle abutment member 22 connected to the force transmission lever 16. As described in more detail below, the person 12 pulls the force transmission lever 16 towards themselves to thereby pull their distal lower leg 24 below the knee forward while maintaining their ankle joint 26 in a stationary position.

In the illustrated example as shown in FIG. 2, the person 12 places their foot 28 on or adjacent the base 14 during use of the joint mobilization appliance 10. The base 14 includes any structure that can be positioned on a floor 30 or can be part of the floor 30 of a structure. For example, the base 14 can be a platform that received the foot 28 thereof. The foot 28 can rest on the platform and be held in position by friction and/or by the ankle abutment member 22. It is contemplated that the platform having the foot 28 therein could include a foot orthotic, wedges of varying degrees of incline to be positioned and repositioned atop of or anteriorly-posteriorly/medially-laterally adjacent to the foot orthotic to modify positioning of the ankle, and/or a heel support, such as those disclosed in U.S. Patent Application Publication No. 2022/0287905 entitled JOINT MOBILIZATION APPLIANCE FOR THE DISTAL LOWER EXTREMITY. However, the foot 28 does not have to be positioned on the base 14. It is merely desired that the base 14 remain stationary during pulling of the force transmission lever 16. The base 14 therefore can also include a suction or other feature to connect the base 14 to the floor 30. Furthermore, the base 14 could include a distal abutment feature to abut the base 14 against a stationary abutment (e.g., a wall) to prevent the base 14 from moving away from the foot 28 during use.

The illustrated force transmission lever 16 is connected to the base 14 and configured to pivot relative thereto. The force transmission lever 16 extends upward from the base 14 and is substantially rigid. The force transmission lever 16 can include a grip feature 32 at a top end 34 thereof to allow the person 12 to easily grasp and pull the top end 34 of the force transmission lever 16 with their hand 36 or hands 36. The grip feature 32 could be an enlarged end, a handle or any other feature that allows the top end 34 to be easily manipulated (e.g., a handle similar to a handle of a shovel). It is further contemplated that the force transmission lever 16 could be adjustable in length to accommodate people of different heights and arm lengths. It is also contemplated that the grip feature 32 could extend towards the person 12 to accommodate for different arm lengths.

In the illustrated example, pulling the force transmission lever 16 causes the force transmission lever 16 to pivot relative to the base 14 and also causes the pull arm 18 connected to the force transmission lever 16 to rotate with the force transmission lever 16. As shown in FIG. 2, the pull arm 18 extends distally away from the person 12. During rotation of the force transmission lever 16 along arrow 44 by pulling the top end 34 thereof towards the person 12, a distal end 38 of the pull arm 18 rotates upward along arrow 46 and relatively away from the person 12. It is contemplated that the pull arm 18 could be adjustable in length and the angle that the pull arm 18 extends from the force transmission lever 16 could be adjustable before use, but the angle of the pull arm 18 should be substantially locked in position during use. It is contemplated that the angle of the pull arm 18 extending away from the force transmission lever 16 could change during use to allow for a greater or lesser force during rotation of the force transmission lever 16 (i.e., resulting in a non-linear movement of the pull arm 18 relative to movement of the force transmission lever 16).

The illustrated ankle abutment member 22 is configured to abut against the front of the ankle joint 26 during use of the joint mobilization appliance 10. As shown in FIG. 2, the ankle abutment member 22 is connected to the force transmission lever 16 and extends towards the person 12. During rotation of the force transmission lever 16 about the arrow 44 by pulling the top end 34 thereof towards the person 12, a proximal end 40 of the ankle abutment member 22 forces the ankle joint 26 to remain in a stationary position. It is contemplated that the ankle abutment member 22 could be adjustable in length and the angle that the ankle abutment member 22 extends from the force transmission lever 16 could be adjustable before use, but the angle of the ankle abutment member 22 should be substantially locked in position during use. It is further contemplated that the ankle abutment member 22 could have a portion thereof biased outward (e.g., by a spring) for a short distance (e.g., half an inch) to provide some cushion against the ankle joint 26 during use. It is also contemplated that the proximal end 40 of the ankle abutment member 22 could include padding or a cushion to press against the ankle joint 26.

In the illustrated example, the pull member 20 pulls the distal lower leg 24 of the person 12 forward during use along arrow 48. The pull member 20 is connected to the distal end 38 of the pull arm 18. The pull member 20 also surrounds the back of the distal lower leg 24 of the person 12. The pull member 20 could be a band or cable 42 that surrounds the force transmission lever 16 and loops around the back of the distal lower leg 24 as shown in FIG. 2. Alternatively, the pull member 20 could be a rigid part pivotally connected to the distal end 38 of the pull arm 18 and surrounding the force transmission lever 16 (e.g., in a Y or U shape) or could extend through an opening in the force transmission lever 16. The pull member 20 could be adjustable in length and can have a cushion or pad on the portion thereof that abuts and pulls against the back of the distal lower leg 24. For example, the band or cable 42 could be lengthened or shortened by using equivalent tightening elements or mechanisms, such as clips, belts, clamps and rings, and/or by using a tensioner and a reel assembly.

In use and operation, the person 12 begins by slowly pulling the top end 34 of the force transmission lever 16 towards the person 12 along arrow 44. As a result of the pivotal movement of the force transmission lever 16, the distal end 38 of the pull arm 18 will pivot upward along arrow 46 and away from the person 12, thereby also pulling the pull member 20 away from the person 12. The ankle abutment member 22 will maintain the ankle joint 26 in a stationary position and the pull member 20 will pull the distal lower leg 24 forward along arrow 48, thereby forcing the ankle joint 26 to bend. Adjustments outlined above in regard to the length and the angle of the force transmission lever 16, the pull arm 18, the pull member 20 and the ankle abutment member 22 can alter the degree of ankle dorsiflexion. The physical therapist can model the joint mobilization appliance 10 and settings, features and uses thereof for the next session to enable the person 12 to perform the ankle dorsiflexion unassisted. In addition to assisted use under the treatment of a physical therapist, the joint mobilization appliance 10 can be used unassisted at home, or in the gym and on the field prior to and during a competition.

It is contemplated that the joint mobilization appliance 10 can also be used by pushing the top end 34 of the force transmission lever 16 away from the person 12, which would result in the distal end 38 of the pull arm 18 pivoting downward and away from the person 12 in a direction opposite to arrow 44, thereby also pulling the pull member 20 away from the person 12. The ankle abutment member 22 will maintain the ankle joint 26 in a stationary position and the pull member 20 will pull the distal lower leg 24 forward, thereby forcing the ankle joint 26 to bend.

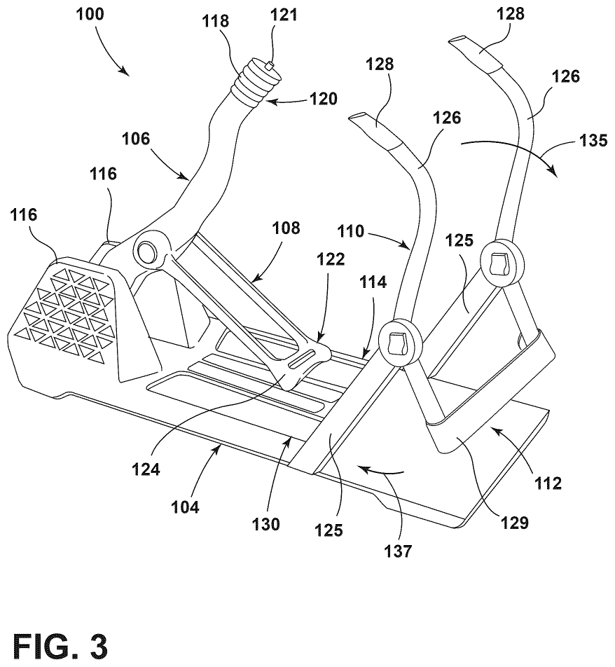

FIG. 3 generally illustrates a second embodiment of a joint mobilization appliance 100 of the present invention for use by a person. The second embodiment of the joint mobilization appliance 100 includes a base 104, a position lever arm 106 pivotally connected to the base 104, an ankle abutment member 108 connected to the position lever arm 106, a force transmission lever 110 connected to the base 104 and a rear leg abutment member 112 connected to the force transmission lever 110. As described in more detail below, the person pulls the force transmission lever 110 towards themselves to thereby pull their distal lower leg below a knee forward while maintaining their ankle joint in a stationary position.

In the illustrated example, the person places their foot in or on the base 104 during use of the second embodiment of the joint mobilization appliance 100. The base 104 includes any structure that can be positioned on a floor or can be part of the floor of a structure. For example, the base 104 can be a platform 114 that received the foot thereof. The foot can rest on the platform 114 and be held in position by the ankle abutment member 108 and friction. It is contemplated that the platform 114 having the foot thereon could include a foot orthotic, wedges of varying degrees of incline to be positioned and repositioned atop of or anteriorly-posteriorly/medially-laterally adjacent to the foot orthotic to modify positioning of the ankle, and/or a heel support, such as those disclosed in U.S. Patent Application Publication No. 2022/0287905 entitled JOINT MOBILIZATION APPLIANCE FOR THE DISTAL LOWER EXTREMITY.

The illustrated platform 114 has the position lever arm 106 rotatably connected thereto. The position lever arm 106 can be substantially rigid and connected to the platform 114 in any manner. For example, as shown in FIG. 3, the platform 114 can include a pair of upwardly extending brackets 116 having a lower end of the position lever arm 106 located therebetween and rotatably connected thereto (e.g., by a pivot pin). The position lever arm 106 is configured to be fixed in a selected rotated position employing a release switch, button or lever 121 on the position lever arm 106 or on the platform 114. Such release switches, buttons and levers 121 to hold a member in a selected rotated position are well known to those skilled in the art. An upper end of the position lever arm 106 can include a grip feature 118 at a top end 120 thereof for easily grasping and rotating the position lever arm 106. The grip feature 118 could be an enlarged end, a handle or any other feature that allows the top end 120 to be easily manipulated (e.g., a handle similar to a handle of a shovel). It is further contemplated that the position lever arm 106 could be adjustable in length to accommodate people of different heights and arm lengths. It is also contemplated that the grip feature 118 could extend towards the person to accommodate for different arm lengths.

In the illustrated example, the ankle abutment member 108 is rotatably connected to the position lever arm 106. The ankle abutment member 108 is configured to abut against the front of the ankle joint during use of the second embodiment of the joint mobilization appliance 100. As shown in FIG. 3, the ankle abutment member 108 is connected to the position lever arm 106 and is configured to extend towards the person. During rotation of the position lever arm 106 by pulling the top end 120 thereof towards the person, a proximal end 122 of the ankle abutment member 108 forces the ankle joint to remain in a stationary position. It is contemplated that the ankle abutment member 108 could be adjustable in length and the angle that the ankle abutment member 108 extends from the position lever arm 106 could be adjustable before use, but the angle of the ankle abutment member 108 should be substantially locked in position during use. It is further contemplated that the ankle abutment member 108 could have a portion thereof biased outward (e.g., by a spring) for a short distance (e.g., half an inch) to provide some cushion against the ankle joint 26 during use. It is also contemplated that the proximal end 122 of the ankle abutment member 108 could include padding or a cushion 124 to press against the ankle joint. It is further contemplated that the release switch, button or lever 121 on the position lever arm 106 or on the platform 114 could be employed to lock and unlock the ankle abutment member 108 from a selected rotated position relative to the position lever arm 106.

During use of the second embodiment of the joint mobilization appliance 100, pulling the force transmission lever 110 causes the rear leg abutment member 112 to also rotate. The force transmission lever 110 can be substantially rigid and connected to the platform 114 in any manner. For example, as shown in FIG. 3, the platform 114 can include a pair of upwardly extending support arms 125 having a lower end of the force transmission lever 110 rotatably connected thereto (e.g., by a pivot pin). In the illustrated example, the force transmission lever 110 includes a pair of separate pull handles 126, but it is contemplated that the pull handles 126 of the force transmission lever 110 could be connected together. The top ends of the pull handles 126 include grips 128 for easily grasping the pull handles 126 to pull the top ends of the pull handles 126 clockwise along arrow 135 as shown in FIG. 3 (i.e., away from the position lever arm 106).

In the illustrated example, pulling the force transmission lever 110 causes the rear leg abutment member 112 to also rotate against the rear of a person's distal lower leg below the knee. As shown in FIG. 3, the rear leg abutment member 112 extends between the lower ends of the pull handles 126 of the force transmission lever 110 below the point where the force transmission lever 110 is rotatably connected to the pair of upwardly extending support arms 125 (although it is contemplated that the rear leg abutment member 112 could be connected to the force transmission lever 110 at any point). Pulling the force transmission lever 110 in the clockwise direction along arrow 135 as shown in FIG. 3 causes the rear leg abutment member 112 to also move in a clockwise direction along arrow 137 to push against the rear of a person's distal lower leg below the knee. The rear leg abutment member 112 could be adjustable in length and the angle that the ankle abutment member 108 extends relative to the force transmission lever 110 could be adjustable before use, but the rear leg abutment member 112 should be substantially locked in position relative to the force transmission lever 110 during use. It is contemplated that the rear leg abutment member 112 could include padding or a cushion 129.

In use and operation, the person begins use of the second embodiment of the joint mobilization appliance 100 by positioning a foot on the platform 114 of the base 104 in a foot placement area 130 at a location that would be between the pair of upwardly extending brackets 116 and the pair of upwardly extending support arms 125, with the toes of the feet facing the position lever arm 106 between the pair of upwardly extending brackets 116. The grip feature 118 of the position lever arm 106 is then pulled towards the person, with the padding or cushion 124 of the ankle abutment member 108 pressing against the ankle to maintain the ankle joint in a stationary position, and then the position lever arm 106 is locked into position. The grips 128 of the pull handles 126 of the force transmission lever 110 are then grasped and pulled toward the person (i.e., in a clockwise direction along arrow 135 as shown in FIG. 3), thereby forcing the rear leg abutment member 112 to rotate toward the rear of a person's distal lower leg below the knee. The padding or cushion 129 of the rear leg abutment member 112 will then press against the rear of a person's distal lower leg below the knee, thereby forcing the ankle joint 26 to bend. The physical therapist can model the second embodiment of the joint mobilization appliance 100 and settings, features and uses thereof for the next session to enable the person to perform the ankle dorsiflexion unassisted. In addition to assisted use under the treatment of a physical therapist, the second embodiment of the joint mobilization appliance 100 can be used unassisted at home, or in the gym and on the field prior to and during a competition.

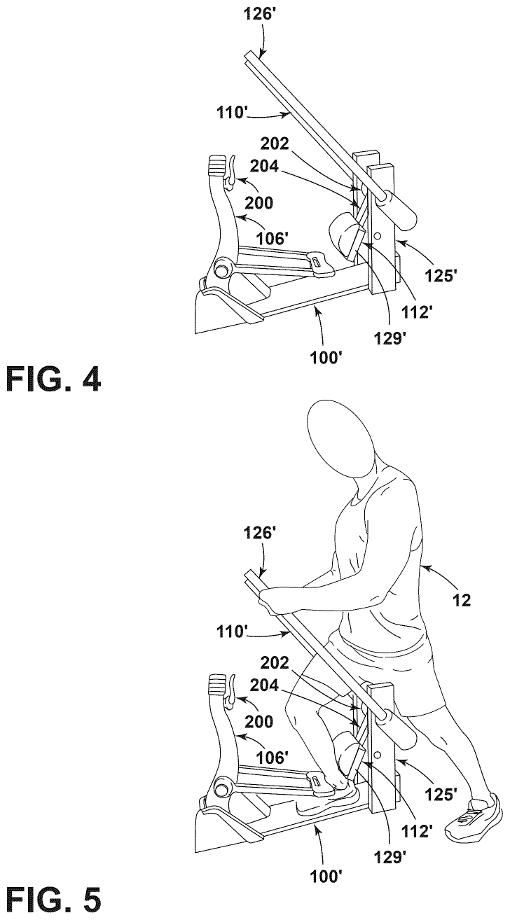

FIGS. 4 and 5 generally illustrate a third embodiment of the joint mobilization appliance 100′ of the present invention for use by the person 12. The third embodiment of the joint mobilization appliance 100′ is similar to the second embodiment of the joint mobilization appliance 100, but includes a lever switch 200 that can be actuated to release the position lever arm 106′ from being fixed in a selected rotated position, and released to fix the position lever arm 106 in a new selected rotated position. Moreover, the pair of separate pull handles 126′ of the force transmission lever 110′ have a slightly different configuration. A pivot member 202 is connected to the pull handles 126′ and extends through the pair of upwardly extending support arms 125′. The rear leg abutment member 112′ includes an arm 204 connected to the pivot member 202 that rotates therewith. The padding or cushion 129′ is connected to the end of the arm 204 of the rear leg abutment member 112′. The third embodiment of the joint mobilization appliance 100′ is used in the same manner as the second embodiment of the joint mobilization appliance 100.

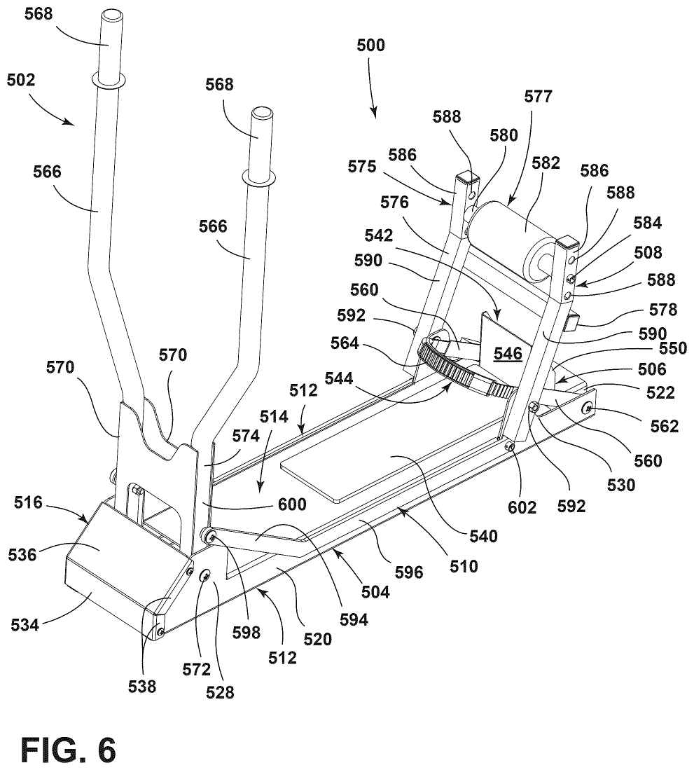

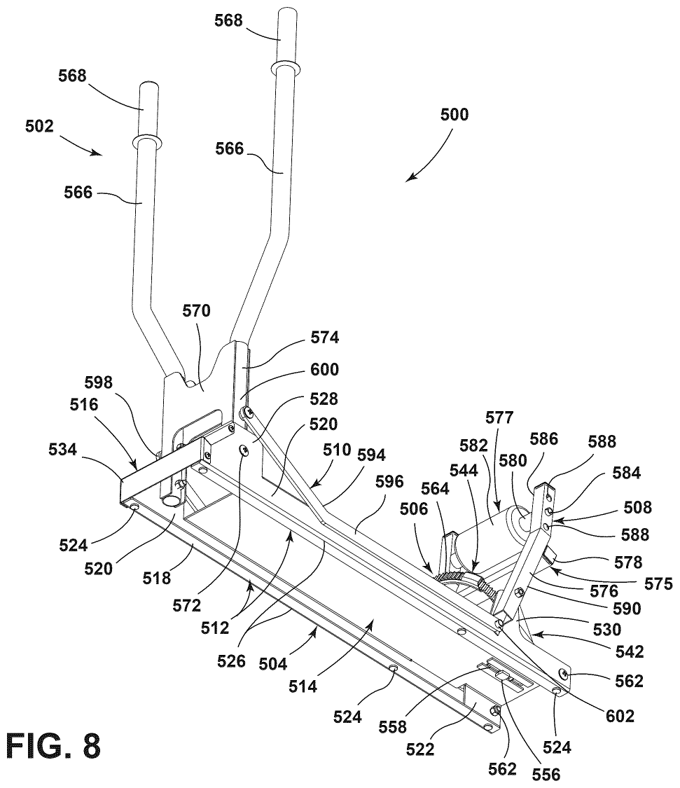

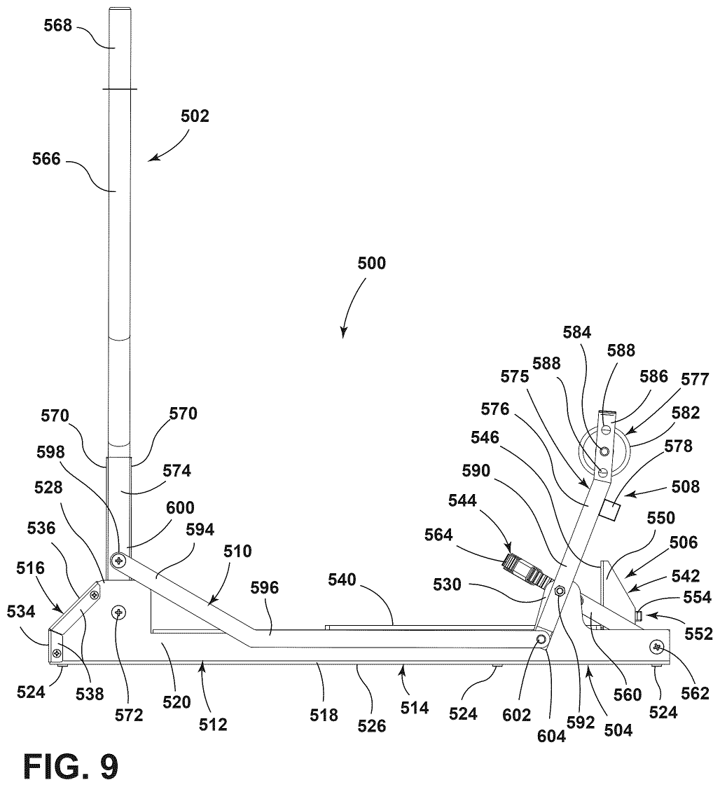

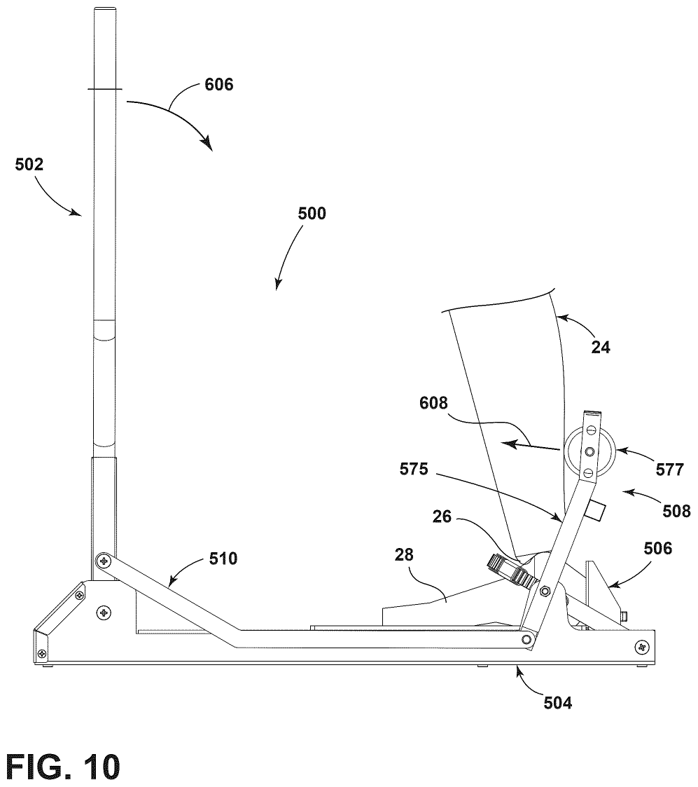

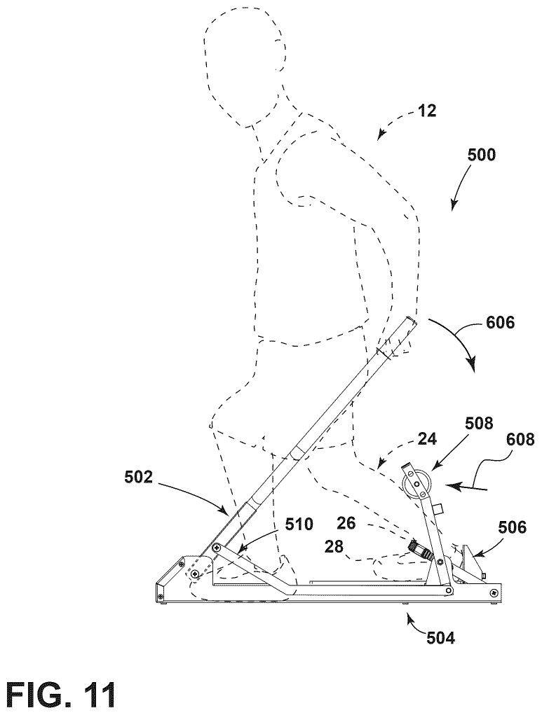

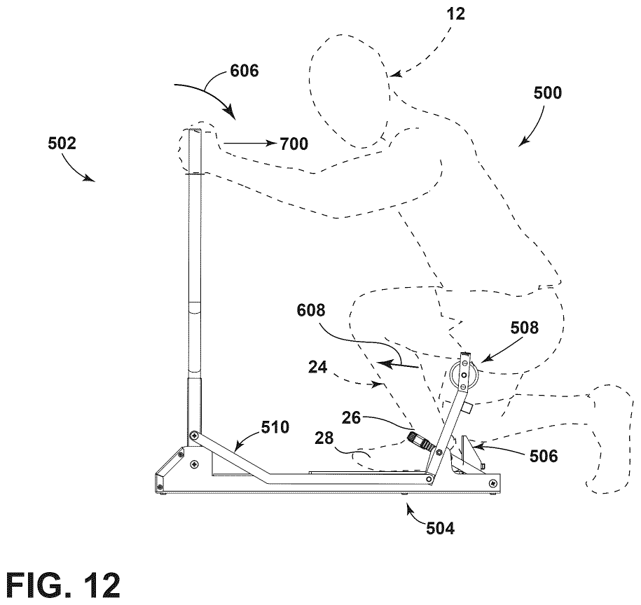

FIGS. 6-9 generally illustrate a fourth embodiment of the joint mobilization appliance 500 of the present invention for use by the person 12 (see FIGS. 11 and 12). The fourth embodiment of the joint mobilization appliance 500 includes a force transmission lever 502 that can be pushed (see FIG. 11) or pulled (see FIG. 12) to thereby push their lower leg 24 below the knee forward while maintaining their ankle joint 26 in a stationary position (see FIG. 10).

The fourth embodiment of the joint mobilization appliance 500 includes a base 504 supporting the force transmission lever 502, a foot stabilization assembly 506 and a lower leg manipulation member 508. The foot stabilization assembly 506 maintains the foot 28 of the person 12 in a fixed position when movement of the force transmission lever 502 forces the lower leg 24 below the knee of the person 12 forward. In the illustrated example, the force transmission lever 502 is forced toward the lower leg manipulation member 508 to move the lower leg manipulation member 508 via a coupling linkage 510 that is coupled between the force transmission lever 502 and the lower leg manipulation member 508.

The illustrated base 504 is configured to be positioned on a floor during use and holds the remaining elements of the fourth embodiment of the joint mobilization appliance 500. The base 504 includes a pair of side rails 512, a bottom plate 514 and a front panel 516. The pair of side rails 512 support the bottom plate 514 and the front panel 516. The base 504 includes two of the side rails 512 facing each other in a mirror image.

Each of the illustrated side rails 512 has a substantially L-shaped cross section with a bottom horizontal section 518 and an outer vertical section 520. Each of the side rails 512 further includes a rear inner vertical section 522. The bottom horizontal section 518 is substantially rectangular and can include a plurality of pads 524 extending downwardly therefrom for positioning on a floor to help hold in place on the floor by friction and/or to provide a cushion between the floor and the base 504. Each of the outer vertical sections 520 includes a lower edge 526 connected to the bottom horizontal section 518. The outer vertical sections 520 include a pair of front upwardly extending ear areas 528 and a pair of rear upwardly extending ear areas 530. As discussed in more detail herein, the force transmission lever 502 is pivotally connected to the pair of front upwardly extending ear areas 528 and the lower leg manipulation member 508 is pivotally connected to the pair of rear upwardly extending ear areas 530. The rear inner vertical section 522 extends upward from an inner edge of the bottom horizontal section 518 at a rear of the pair of rear upwardly extending ear areas 530 to form an upwardly opening channel 532.

In the illustrated example, the front panel 516 covers a front of the base 504. The front panel 516 is bent and includes a lower vertical portion 534 and an upper angled portion 536. Both the lower vertical portion 534 and the upper angled portion 536 have side flanges 538 to extend over a front of the outer vertical section 520 of the side rails 512 and a front of the pair of front upwardly extending ear areas 528. While the front panel 516 and the side rails 512 are shown as being separate and having a particular configuration, it is contemplated that the front panel 516 and the side rails 512 could be integral and have any configuration at a front of the base 504.

The illustrated bottom plate 514 of the base 504 extends between and connects the side rails 512 together. In the illustrated example, the bottom plate 514 extends between the rails 512 at a location from behind the pair of front upwardly extending ear areas 528 to a rear location of the pair of rear upwardly extending ear areas 530, along with extending between the rear inner vertical section 522 to thereby leave the upwardly opening channel 532 accessible.

In the illustrated example, the foot stabilization assembly 506 stabilizes the foot 28 of the person 12 during use of the fourth embodiment of the joint mobilization appliance 500. The foot stabilization assembly 506 includes a foot pad 540, a heel brace 542 and an ankle strap 544. The foot pad 540 can comprise a foot orthotic that can be detachably coupled to the bottom plate 514 of the base 504. The foot pad 540 can include an upper surface with a hook and loop fastener for easy positioning and repositioning of arch support and wedges of varying degrees of incline can be positioned and repositioned atop of or anteriorly-posteriorly/medially-laterally adjacent to the foot orthotic. The foot orthotic and wedges can be formed or constructed or manufactured from semi-rigid materials, such as foams, silicones, and thermoplastics and can be infused with antibacterial materials.

The illustrated heel brace 542 of the foot stabilization assembly 506 is configured to maintain the heel of the foot 28 of the person 12 in position during use of the fourth embodiment of the joint mobilization appliance 500. It is contemplated that the heel brace 542 can be adjusted forward and rearward or fixed. In the illustrated embodiment, the heel brace 542 includes a vertical support wall 546 (that could be padded), a horizontal plate 548 and a pair of side spanning flanges 550 extending between the vertical support wall 546 and the horizontal plate 548. A fixing dial 552 can be used to lock the heel brace 542 in position. The fixing dial 552 includes a knob 554 that is threaded onto a screw having a bottom plate 556. The screw extends through a hole in the horizontal plate 548 of the heel brace 542 and a slot 558 in the bottom plate 514 at a location between the channels 532. The fixing dial 552 can be tightened to fix the heel brace 542 in a desired location along the slot 558. The fixing dial 552 is fixed by rotating the knob 554 relative to the screw, thereby pulling the bottom plate 556 of the fixing dial 552 against the bottom surface of the bottom plate 514 to lock the fixing dial 552 in position by friction. However, it is contemplated that the heel brace 542 could be fixed in position in a selected location on the bottom plate 514 in any manner or could not be adjustable.

In the illustrated example, the ankle strap 544 surround the ankle of the person 12 and maintains the foot 28 in position on the foot stabilization assembly 506. The ankle strap 544 includes a pair of strap portions 560 that extend into the upwardly opening channel 532 of the pair of side rails 512 of the base 504. The strap portions 560 of the ankle strap 544 can be pivotally connected to the pair of side rails 512 by pivot pins 562. The strap portions 560 of the ankle strap 544 are configured to be connected together at a flexible and padded front connection device 564. The flexible and padded front connection device 564 (e.g., a clip) allow the strap portions 560 to be loosened or separated to allow the foot 28 of the person 12 to easily be positioned on the foot pad 540 and then tightened to press against the front of the ankle joint 26 of the person 12 in a comfortable manner. It is contemplated that the ankle strap 544 could be formed of any material and have any loosening and tightening mechanism (e.g., a ratchet device).

The illustrated force transmission lever 502 of the fourth embodiment of the joint mobilization appliance 500 can be moved toward the ankle joint 26 to thereby push the lower leg 24 of the person 12 below the knee forward while maintaining their ankle joint 26 in a stationary position. The force transmission lever 502 includes any lever that can be moved to force the lower leg manipulation member 508 forward. In the illustrated example, the force transmission lever 502 is pivotally connected to the pair of front upwardly extending ear areas 528 of the outer vertical sections 520 of the side rails 512 of the base 504 by a bottom pivot pin or pins 572 to allow the force transmission lever 502 to rotate about the base 504.

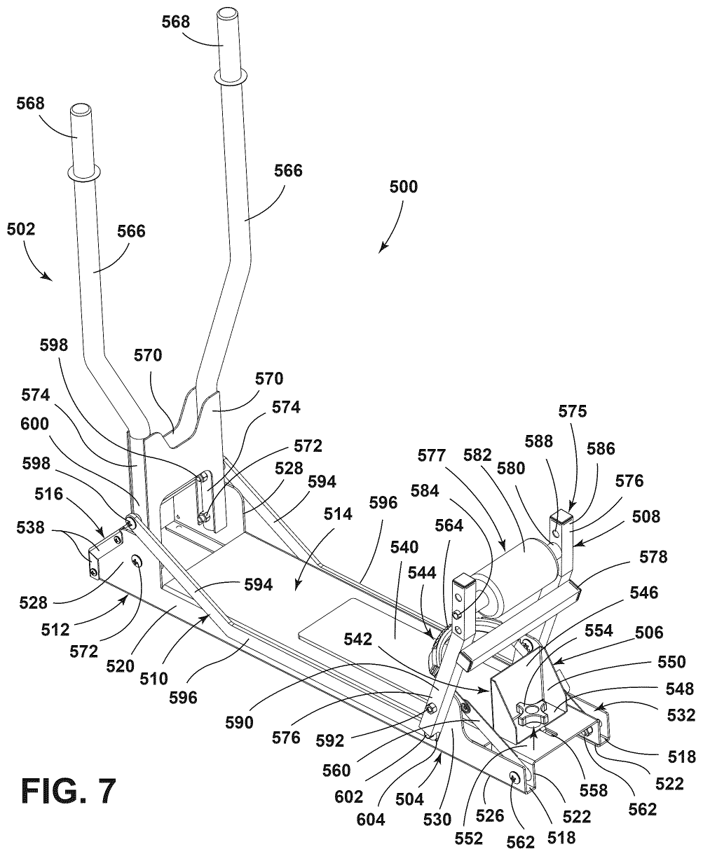

In the illustrated example, the force transmission lever 502 includes a pair of rods 566 having grip handles 568 on top ends thereof that allow the pair of rods 566 to be grasped and rotated about the bottom pivot pin or pins 572. While the rods 566 are illustrated as being separated with each having one of the grip handles 568, it is contemplated that the force transmission lever 502 could be a single device with any grip feature. The rods 566 of the force transmission lever 502 can include bottom areas 574 that are connected together by a pair of M-shaped plates 570 as illustrated in FIGS. 6 and 7 to provide stability to the force transmission lever 502 and to ensure that the rods 566 are rotated about the pivot pin or pins 572 as a unit (i.e., together with the same amount of rotation).

Rotation of the illustrated force transmission lever 502 results in movement of the lower leg manipulation member 508 forward. The lower leg manipulation member 508 includes a support frame 575 and a leg abutment member 577. The support frame 575 comprises a pair of side bars 576 connected to each other by a rear brace 578. The side bars 576 and the rear brace 578 can have any cross-sectional shape (e.g., rectangular as shown) and can be integral or connected (e.g., by fasteners or welding). The side bars 576 each include a bottom portion 590 pivotally connected to the pair of rear upwardly extending ear areas 530 of the outer vertical sections 520 of the side rails 512 of the base 504 by upper pivot pins 592 to allow the support frame 575 and thereby the lower leg manipulation member 508 to rotate about the base 504.

The illustrated leg abutment member 577 extends between the side bars 576 at a top portion 586 of the side bars 576. The leg abutment member 577 includes a cross bar 580 having an abutment pad 582 thereof. It is contemplated that the abutment pad 582 could have any shape (e.g., cylindrical as shown or merely on a front of the cross bar 580) and can have a padded area for abutment with the lower leg 24. The cross bar 580 includes a pair of aligned pins 584 extending outwardly from each end thereof. It is contemplated that the cross bar 580 can be telescopically collapsible and biased outward (like a toilet paper holder) or that the pins 584 can be biased outward. As shown in FIGS. 6-9, the top portion 586 of each of the side bars 576 include a series of vertically aligned holes 588. It is contemplated that any number of holes 588 could be used (e.g., three on each of the side bars 576 as shown). The pins 584 of the cross bar 580 are configured to extend into (and through as shown) a pair of the vertically aligned holes 588. The pins 584 can be removed from the holes 588 to move the cross bar 580 and the abutment pad 582 vertically on the support frame 575 to accommodate different heights of the person 12 using the fourth embodiment of the joint mobilization appliance 500 or to position the cross bar 580 at different vertical locations as desired. Once moved, the pins 584 are then inserted into another pair of aligned holes 588 in the top portion 586 of each of the side bars 576.

In the illustrated example, as the force transmission lever 502 is moved toward the lower leg manipulation member 508, the coupling linkage 510 forces the lower leg manipulation member 508 to rotate along arrow 608 as illustrated in FIG. 10. The coupling linkage 510 comprises a pair of elongated rails 596 having a front, angled portion 594. Each of the elongated rails 596 are connected to and between the force transmission lever 502 and the lower leg manipulation member 508. The front, angled portion 594 of each of the elongated rails 596 of the coupling linkage 510 is pivotally connected to a middle portion 600 of the bottom areas 574 of the rods 566 of the force transmission lever 502 at a front pivot point 598 (e.g., by a pivot pin or a pair of pivot pins).

Each of the elongated rails 596 of the coupling linkage 510 are configured to move rearward as the force transmission lever 502 is moved toward the lower leg manipulation member 508. The front pivot point 598 of each of the elongated rails 596 of the coupling linkage 510 is located above the bottom pivot pin or pins 572 that connect the force transmission lever 502 to the pair of front upwardly extending ear areas 528 of the outer vertical sections 520 of the side rails 512 of the base 504. Therefore, as the force transmission lever 502 is moved rearward along arrow 606 as shown in FIG. 11, such movement also causes rearward movement of the elongated rails 596 of the coupling linkage 510.

In the illustrated example, rearward movement of the elongated rails 596 of the coupling linkage 510 causes the lower leg manipulation member 508 to rotate forward about arrow 608 as shown in FIG. 10. The rear of each of the elongated rails 596 is pivotally coupled at a bottom end 604 of the bottom portion 590 of the side bars 576 of the support frame 575 of the lower leg manipulation member 508 at a rear pivot point 602 (e.g., by a pivot pin for each elongated rail 596). The rear pivot point 602 of each of the elongated rails 596 of the coupling linkage 510 is located below the upper pivot pins 592 that connect the bottom portion 590 of the side bars 576 of the support frame 575 of the lower leg manipulation member 508. Therefore, as the elongated rails 596 of the coupling linkage 510 are moved rearward, such movement also causes rearward movement of the bottom end 604 of the bottom portion 590 of the side bars 576 of the support frame 575 of the lower leg manipulation member 508 to move rearward, thereby rotating the lower leg manipulation member 508 along arrow 608 as shown in FIG. 10.

FIG. 11 illustrates a method of using the fourth embodiment of the joint mobilization appliance 500 of the present invention in use by a person 12 in a first body position. In the first body position of FIG. 11, the force transmission lever 502 is pushed down between the person's legs. The force transmission lever 502 can then be pushed downward along arrow 606 to move the coupling linkage 510 rearward to thereby rotate the lower leg manipulation member 508 along arrow 608. Such movement will push the lower leg manipulation member 508 forward against the lower leg 24 below the knee to push the lower leg 24 below the knee forward while maintaining their ankle joint 26 and foot 28 in a stationary position.

FIG. 12 illustrates a method of using the fourth embodiment of the joint mobilization appliance 500 of the present invention in use by a person 12 in a second body position. In the second body position of FIG. 12, the force transmission lever 502 is pulled rearward along arrow 606 by a person kneeling (as shown) or standing by having the person pull their hands in along arrow 700. The force transmission lever 502 then moves the coupling linkage 510 rearward to thereby rotate the lower leg manipulation member 508 along arrow 608. Such movement will push the lower leg manipulation member 508 forward against the lower leg 24 below the knee to push the lower leg 24 below the knee forward while maintaining their ankle joint 26 and foot 28 in a stationary position.

In use, the first embodiment of the joint mobilization appliance 10 and the fourth embodiment of the joint mobilization appliance 500 employ the force transmission lever 16, 502 that is forced towards the ankle joint 26, with an axis of rotation of the force transmission lever 16, 502 that is located in front of the person 12 using the first embodiment of the joint mobilization appliance 10 and the fourth embodiment of the joint mobilization appliance 500. Moreover, both the first embodiment of the joint mobilization appliance 10 and the fourth embodiment of the joint mobilization appliance 500 force the lower leg 24 below the knee forward, with the first embodiment of the joint mobilization appliance 10 pulling on the lower leg 24 below the knee and the fourth embodiment of the joint mobilization appliance 500 pushing the lower leg 24 below the knee.

In use, the second embodiment of the joint mobilization appliance 100, the third embodiment of the joint mobilization appliance 100′ and the fourth embodiment of the joint mobilization appliance 500 employ the force transmission lever 16, 502 that can be pulled by the person towards their body to push the lower leg 24 below the knee forward with the rear leg abutment member 112, 577. Likewise, the second embodiment of the joint mobilization appliance 100, the third embodiment of the joint mobilization appliance 100′ and the fourth embodiment of the joint mobilization appliance 500 all have the ankle joint 26 fixed in position during use thereof.

Although particular preferred embodiments of the invention have been disclosed in detail for illustrative purposes, it will be recognized that variations or modifications of the disclosed apparatus, including the rearrangement of parts, lie within the scope of the present invention.

1. A joint mobilization appliance comprising:
a base having a foot receiving area;
a force transmission lever pivotally connected to and extending upwardly from the base, an upper portion of the force transmission lever distal the base being configured to be rotated toward the foot receiving area of the base;
an ankle abutment member configured to abut against an ankle joint of a person using the joint mobilization appliance; and
a rear leg abutment member interconnected to the force transmission lever;
in use, rotation of the force transmission lever forces the rear leg abutment member against a back of a distal lower leg below a knee of the person to force the back of the distal lower leg below the knee of the person forward to force ankle dorsiflexion.

2. The joint mobilization appliance of claim 1, wherein:
the base includes a foot stabilization assembly comprising a heel brace and the ankle abutment member for holding the ankle joint of the person using the joint mobilization appliance in place during rotation of the force transmission lever, the ankle abutment member including an ankle strap.

3. The joint mobilization appliance of claim 1, wherein:
rotation of the force transmission lever forces the rear leg abutment member to push the back of the distal lower leg below the knee of the person forward.

4. The joint mobilization appliance of claim 1, wherein:
rotation of the force transmission lever forces the rear leg abutment member to pull the back of the distal lower leg below the knee of the person forward.

5. The joint mobilization appliance of claim 1, wherein:
rotation of the force transmission lever forces an ankle abutment member connected to the force transmission lever toward the foot receiving area of the base such that the ankle abutment member is configured to push against the ankle joint.

6. The joint mobilization appliance of claim 1, wherein:
rotation of the force transmission lever in a first direction about a first axis of rotation causes the rear leg abutment member to rotate about a second axis of rotation in a second direction opposite to the first direction, with the first axis of rotation and the second axis of rotation being substantially parallel.

7. The joint mobilization appliance of claim 1, wherein:
the force transmission lever is connected to the rear leg abutment member by a coupling linkage.

8. The joint mobilization appliance of claim 7, wherein:
the force transmission lever is pivotally connected to the base at a first pivot point;
the coupling linkage is connected to the force transmission lever at a second pivot point;
the coupling linkage is connected to the rear leg abutment member at a third pivot point; and
the rear leg abutment member is pivotally connected to the base at a fourth pivot point.

9. The joint mobilization appliance of claim 8, wherein:
the first pivot point is located between the second pivot point and a bottom of the base; and
the third pivot point is located between the fourth pivot point and the bottom of the base.

10. A joint mobilization appliance comprising:
a base having a foot receiving area;
a force transmission lever pivotally connected to and extending upwardly from the base, an upper portion of the force transmission lever distal the base being configured to be rotated by a person using the joint mobilization appliance;
an ankle position fixing member configured to fix an ankle joint of a person using the joint mobilization appliance in a locked position; and
a rear leg abutment member interconnected to the force transmission lever;
in use, rotation of the force transmission lever forces the rear leg abutment member to push against a back of a distal lower leg below a knee of the person to force the back of the distal lower leg below the knee of the person forward to force ankle dorsiflexion.

11. The joint mobilization appliance of claim 10, wherein:
the base includes a foot stabilization assembly comprising a heel brace and the ankle abutment member for holding the ankle joint of the person using the joint mobilization appliance in place during rotation of the force transmission lever, the ankle abutment member including an ankle strap.

12. The joint mobilization appliance of claim 10, wherein:
the rear leg abutment member is fixed to and moves with the force transmission lever.

13. The joint mobilization appliance of claim 12, wherein:
the rear leg abutment member and the force transmission lever rotate about a single axis of rotation.

14. The joint mobilization appliance of claim 10, wherein:
rotation of the force transmission lever in a first direction about a first axis of rotation causes the rear leg abutment member to rotate about a second axis of rotation in a second direction opposite to the first direction, with the first axis of rotation and the second axis of rotation being substantially parallel.

15. The joint mobilization appliance of claim 10, wherein:
the force transmission lever is connected to the rear leg abutment member by a coupling linkage.

16. The joint mobilization appliance of claim 15, wherein:
the force transmission lever is pivotally connected to the base at a first pivot point;
the coupling linkage is connected to the force transmission lever at a second pivot point;
the coupling linkage is connected to the rear leg abutment member at a third pivot point; and
the rear leg abutment member is pivotally connected to the base at a fourth pivot point.

17. The joint mobilization appliance of claim 16, wherein:
the first pivot point is located between the second pivot point and a bottom of the base; and
the third pivot point is located between the fourth pivot point and the bottom of the base.

18. A joint mobilization appliance comprising:
a base;
a lever pivotally connected to and extending upwardly from the base;
a pull arm extending in a distal direction from a first side of the lever;
an ankle abutment member extending in a proximal direction from a second side of the lever; and
a pull member connected at a distal end of the pull arm;
wherein rotation of the lever will force the distal end of the pull arm to pull the pull member in the distal direction opposite to the proximal direction; and
in use, the ankle abutment member abuts against an ankle of a person to maintain the ankle in a stationary position while the pull member pulls a back of a distal lower leg below a knee of the person forward toward the distal direction to force ankle dorsiflexion.

19. A joint mobilization appliance comprising:
a base;
a lever arm pivotally connected to and extending upwardly from the base;
an ankle abutment member extending from the lever arm; and
a pull lever pivotally connected to the base;
the pull lever having a rear leg abutment member connected thereto to rotate with rotation of the pull lever;
in use, the ankle abutment member abuts against an ankle of a person to maintain the ankle in a stationary position while the pull lever pushes the rear leg abutment member against a back of a distal lower leg below a knee of the person to push the back of the distal lower leg below the knee of the person forward to force ankle dorsiflexion.
